(19) United States
(12) Patent Application Publication
(10) Pub. No.: US 2012/0012520 A1
(43) Pub. Date: Jan. 19, 2012

(54) FORWARD OSMOSIS MEMBRANES AND METHOD FOR FABRICATING THE SAME

(75) Inventors: Seock Heon LEE, Seoul (KR); Young Beom YU, Seoul (KR); Sun Keun SEO, Incheon (KR)

(73) Assignee: KOREA INSTITUTE OF SCIENCE AND TECHNOLOGY, Seoul (KR)

(21) Appl. No.: 13/177,795

(22) Filed: Jul. 7, 2011

(30) Foreign Application Priority Data
Jul. 16, 2010 (KR) 10-2010-0068775

(51) Int. Cl. B01D 71/06; B01D 71/56; B05D 5/00; B01D 71/68; B01D 71/42; B82Y 30/00

(52) U.S. Cl. 210/490; 427/245; 977/780

(57) ABSTRACT

Disclosed are a forward osmosis membrane capable of ensuring resistance to microorganisms, improving water flux by forward osmosis, and minimizing reverse solute flux by maximizing tortuosity of the membrane, and a method for fabricating the same. The disclosed method for fabricating a forward osmosis membrane includes: preparing a filler material including a non-cellulose polymer, an organic solvent for dissolving the non-cellulose polymer, and a pore-forming agent for inducing pore formation in the non-cellulose polymer; coating the filler material on an osmosis membrane backing; and immersing the osmosis membrane backing coated with the filler material in water, so that the organic solvent and the pore-forming agent are evaporated, and pores are formed in the non-cellulose polymer as the non-cellulose polymer is solidified.

### CROSS-REFERENCE TO RELATED APPLICATIONS

This application claims priority under 35 U.S.C. §119 to Korean Patent Application No. 10-2010-0068775, filed on Jul. 16, 2010, in the Korean Intellectual Property Office, the disclosure of which is incorporated herein by reference in its entirety.

### BACKGROUND

1. Field

The present disclosure relates to a forward osmosis membrane and a method for fabricating the same. More particularly, it relates to a forward osmosis membrane having resistance to microorganisms, capable of improving water flux through forward osmosis, and having maximized tortuosity so as to prevent reverse solute flux, and a method for fabricating the same.

2. Description of the Related Art

In order to acquire fresh water or graywater from seawater or wastewater, dissolved or floating impurities should be removed. Currently, water treatment based on reverse osmosis is employed widely in order to convert seawater or wastewater to fresh water or graywater.

In water treatment processes based on reverse osmosis, a pressure corresponding to the osmotic pressure induced by the dissolved solutes should be applied to the feed water in order to separate the solutes such as salts (e.g., NaCl) from the water. Typically, the concentration of salts dissolved in seawater is 30,000-45,000 ppm and the osmotic pressure induced thereby is approximately 20-30 atm. In order to produce fresh water from the feed water, a pressure exceeding 20-30 atm has to be applied to the feed water. Thus, an energy of at least 6-10 kW/m³ is required to produce 1 m³ of fresh water from seawater.

Although energy recovery systems have been developed recently and used to reduce energy consumption in reverse osmosis processes, even in that case, an energy of at least about 3 kW/m³ is required to drive the motor of a high-pressure pump.

To solve this problem, a water treatment process using a forward osmosis membrane has recently been presented as a solution. Since the forward osmosis process utilizes the natural osmosis phenomenon, it is very economical as compared to the reverse osmosis process because it is not necessary to apply an external pressure. Accordingly, studies are actively carried out to develop forward osmosis membranes.

Currently, the forward osmosis membrane made from cellulose triacetate (CTA), developed and commercialized by Hydration Technology, Inc. (HTI) of the US, is the most widely used. The HTI's CTA membrane has a hydrophilic cellulose-based surface and a total membrane thickness of 50-100 μm. It exhibits a high water flux of 5.1 μm/cm under a relatively high osmotic pressure condition of an 3 M NaCl aqueous solution. However, the HTI's CTA membrane is disadvantageous in that it has weak resistance to microorganisms and reverse solute flux occurs.

### SUMMARY

The present disclosure is directed to providing a forward osmosis membrane having resistance to microorganisms, capable of improving water flux through forward osmosis, and having maximized tortuosity so as to prevent reverse solute flux, and a method for fabricating the same.

In one general aspect, the present disclosure provides a forward osmosis membrane including: an osmosis membrane backing made of a porous material; an active layer provided on the osmosis membrane backing; and a support layer provided in the osmosis membrane backing, wherein the active layer and the support layer are made of a non-cellulose polymer.

The non-cellulose polymer may be one of polyethersulfone (PES) and polyacrylonitrile (PAN). The active layer may be 0.5-50 μm thick, and the active layer plus the osmosis membrane backing may be 50-250 μm thick. The osmosis membrane backing may be a nonwoven or nylon fabric having pores with a diameter of 0.1-100 μm.

In another general aspect, the present disclosure provides a method for fabricating a forward osmosis membrane including: preparing a filler material including a non-cellulose polymer, an organic solvent for dissolving the non-cellulose polymer, and a pore-forming agent for inducing pore formation in the non-cellulose polymer; coating the filler material on an osmosis membrane backing; and immersing the osmosis membrane backing coated with the filler material in water, so that the organic solvent and the pore-forming agent are evaporated, and pores are formed in the non-cellulose polymer as the non-cellulose polymer is solidified.

The filler material may be a mixture of 10-30 vol % of the non-cellulose polymer, 50-85 vol % of the organic solvent, and 5-20 vol % of the pore-forming agent. The non-cellulose polymer may be one of polyethersulfone (PES) and polyacrylonitrile (PAN). The organic solvent may be dimethylacetamide (DMAc), dimethylformamide (DMF), N-methylpyrrolidone (NMP) or a combination thereof. And, the pore-forming agent may be 1,3-dioxalane, polyvinylpyrrolidone (PVP), polyethylene glycol (PEG), acetone or a combination thereof.

When the osmosis membrane backing coated with the filler material is immersed in water, so that the organic solvent and the pore-forming agent are evaporated, and pores are formed in the non-cellulose polymer as the non-cellulose polymer is solidified, an active layer may be formed on the osmosis membrane backing and a support layer may be formed in the osmosis membrane backing as the organic solvent and the pore-forming agent are evaporated. Furthermore, an sub-active layer may be formed below the osmosis membrane backing in addition to the support layer.

Other features and aspects will be apparent from the following detailed description, the drawings, and the claims.

### BRIEF DESCRIPTION OF THE DRAWINGS

The above and other objects, features and advantages of the present disclosure will become apparent from the following description of certain exemplary embodiments given in conjunction with the accompanying drawings, in which:

FIG. 1 is a cross-sectional view of a forward osmosis membrane fabricated according to an embodiment of the present disclosure;

FIG. 2 is a cross-sectional view of a forward osmosis membrane fabricated according to another embodiment of the present disclosure;

FIGS. 3a and FIG. 3b respectively show an osmosis membrane backing comprising a nonwoven fabric and an osmosis membrane backing comprising a nylon fabric;

FIG. 4 schematically illustrates a method for fabricating a forward osmosis membrane according to an embodiment of the present disclosure;

FIG. 5 is a flowchart illustrating a method for fabricating a forward osmosis membrane according to an embodiment of the present disclosure;

FIG. 6a and FIG. 6b are photographic images of forward osmosis membranes including different amount of a non-cellulose polymer;

FIG. 7 compares water flux and reverse solute flux properties of a forward osmosis membrane made from Hydration Technology, Inc. (HTI)'s cellulose triacetate (CTA) and a forward osmosis membrane made from polyethersulfone (PES) according to an embodiment of the present disclosure; and

FIG. 8 is a photographic image of a forward osmosis membrane according to the existing art.

### DETAILED DESCRIPTION OF EMBODIMENTS

The advantages, features and aspects of the present disclosure will become apparent from the following description of the embodiments with reference to the accompanying drawings, which is set forth hereinafter. The present disclosure may, however, be embodied in different forms and should not be construed as limited to the embodiments set forth herein. Rather, these embodiments are provided so that this disclosure will be thorough and complete, and will fully convey the scope of the present disclosure to those skilled in the art. The terminology used herein is for the purpose of describing particular embodiments only and is not intended to be limiting of the example embodiments. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof.

Hereinafter, exemplary embodiments will be described in detail with reference to the accompanying drawings.

A forward osmosis membrane according to the present disclosure comprises a combination of an osmosis membrane backing and a filler material. The osmosis membrane backing defines the external form of the forward osmosis membrane and provides a space in which the filler material is accommodated. The filler material is provided not only in the osmosis membrane backing but also optionally above and below the osmosis membrane backing to perform forward osmosis.

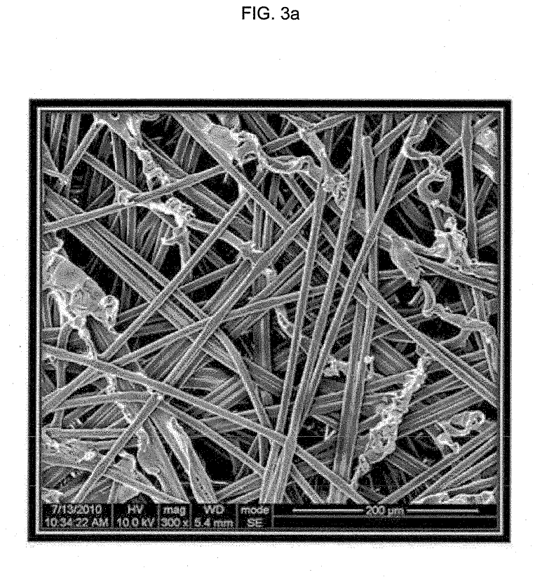

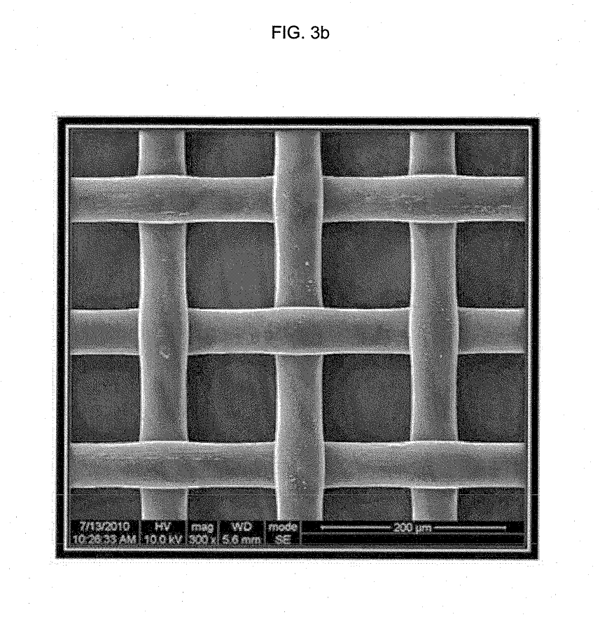

The osmosis membrane backing may be made of a porous fabric having pores with a diameter of 0.1-100 μm. For example, a nonwoven fabric (see FIG. 3a) or a nylon fabric (see FIG. 3b) may be used. The filler material may comprise a hydrophilic material having resistance to microorganisms. It may comprise a non-cellulose polymer. Specifically, be one of polyethersulfone (PES) and polyacrylonitrile (PAN) may be used.

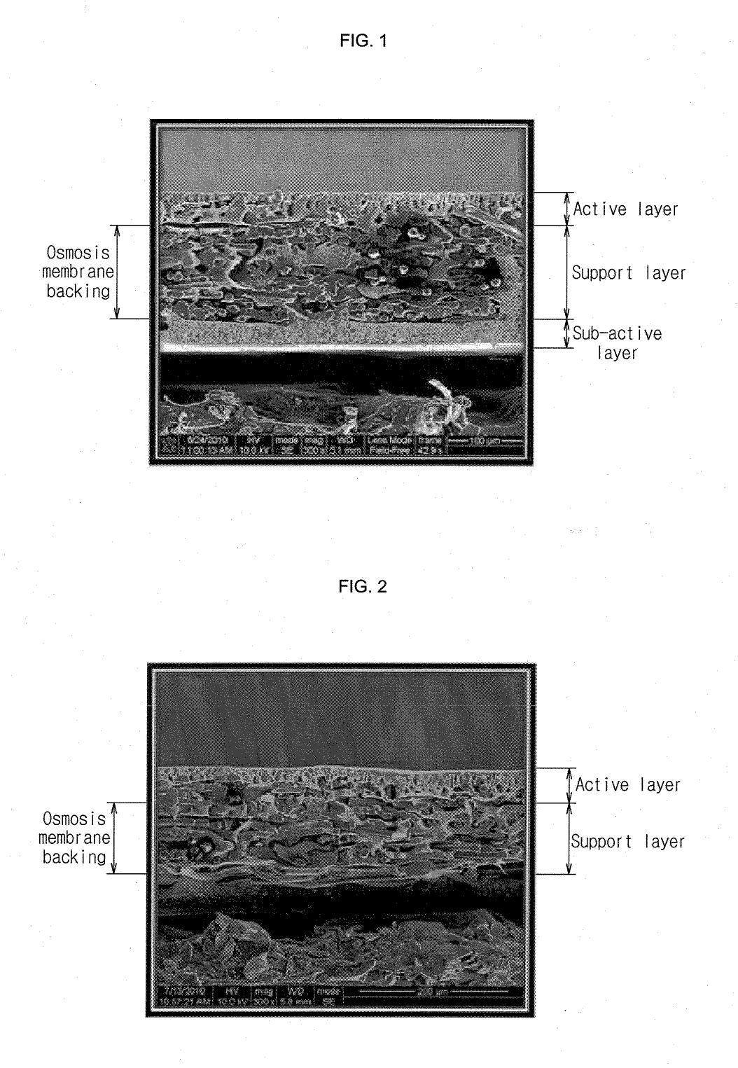

Referring to FIG. 1 and FIG. 2, the filler material comprises an active layer provided above the osmosis membrane backing and a support layer provided in the osmosis membrane backing. Furthermore, a sub-active layer may be provided below the osmosis membrane backing. The active layer, the support layer and the sub-active layer have multiple pores. The pores on the surface of the active layer and the sub-active layer may have a diameter of 0.01-10 nm.

The active layer and the support layer carry out forward osmosis in the forward direction. In the reverse direction, the support layer suppresses reverse solute flux. This is accomplished since coupling of the osmosis membrane backing with the support layer results in maximized tortuosity leading to minimized solute flux in the reverse direction. In addition, the sub-active layer may be provided below the osmosis membrane backing as described above. The provision of the sub-active layer further suppresses the reverse solute flux. In contrast, since the existing forward osmosis membrane simply has a polymer coating layer provided on the osmosis membrane backing, as shown in FIG. 8, reverse solute flux cannot be avoided. For reference, the forward osmosis membrane of the present disclosure has a structure wherein the osmosis membrane backing, the joining part of the osmosis membrane backing and the support layer, and the active layer are engaged with one another.

In the forward osmosis membrane according to the present disclosure, the active layer and the sub-active layer may be 0.5-50 μm thick, and the forward osmosis membrane may be 50-250 μm thick as a whole. The active layer and the sub-active layer may have pores with a diameter of 0.01-10 nm.

Next, a method for fabricating a forward osmosis membrane according to the present disclosure will be described.

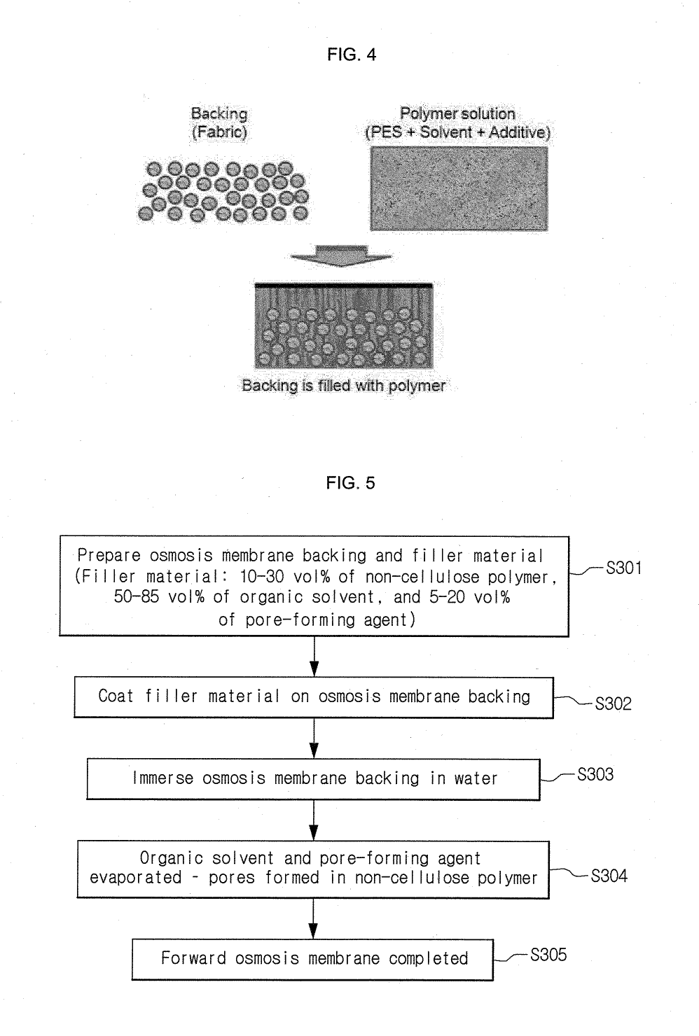

First, as shown in FIG. 4 and FIG. 5, an osmosis membrane backing and a filler material (polymer solution) are prepared (S301). The osmosis membrane backing may be a nonwoven or nylon fabric having pores with a diameter of 0.1-100 μm. The filler material may be a liquid material prepared by mixing a non-cellulose polymer with an organic solvent. In addition to the polymer and the organic solvent, a pore-forming agent may be further mixed.

The non-cellulose polymer is a solid material substantially constituting the filler material and may be one of polyethersulfone (PES) and polyacrylonitrile (PAN). The organic solvent dissolves the non-cellulose polymer and forms pores in the non-cellulose polymer in the evaporation process that follows. The organic solvent may be dimethylacetamide (DMAc), dimethylformamide (DMF), N-methylpyrrolidone (NMP) or a combination thereof. The pore-forming agent is a highly volatile substance and forms fine pores in the non-cellulose polymer during the evaporation process. 1,3-Dioxalane, polyvinylpyrrolidone (PVP), polyethylene glycol (PEG), acetone or a combination thereof may be used.

When mixing the non-cellulose polymer, the organic solvent and the pore-forming agent, 10-30 vol % of the non-cellulose polymer, 50-85 vol % of the organic solvent and 5-20 vol % of the pore-forming agent may be mixed. The proportion of the pore-forming agent may be adjusted depending on the desired pore size. The mixing proportion of the organic solvent is dependent on that of the non-cellulose polymer. The larger the mixing proportion of the pore-forming agent, the smaller is the pore size.

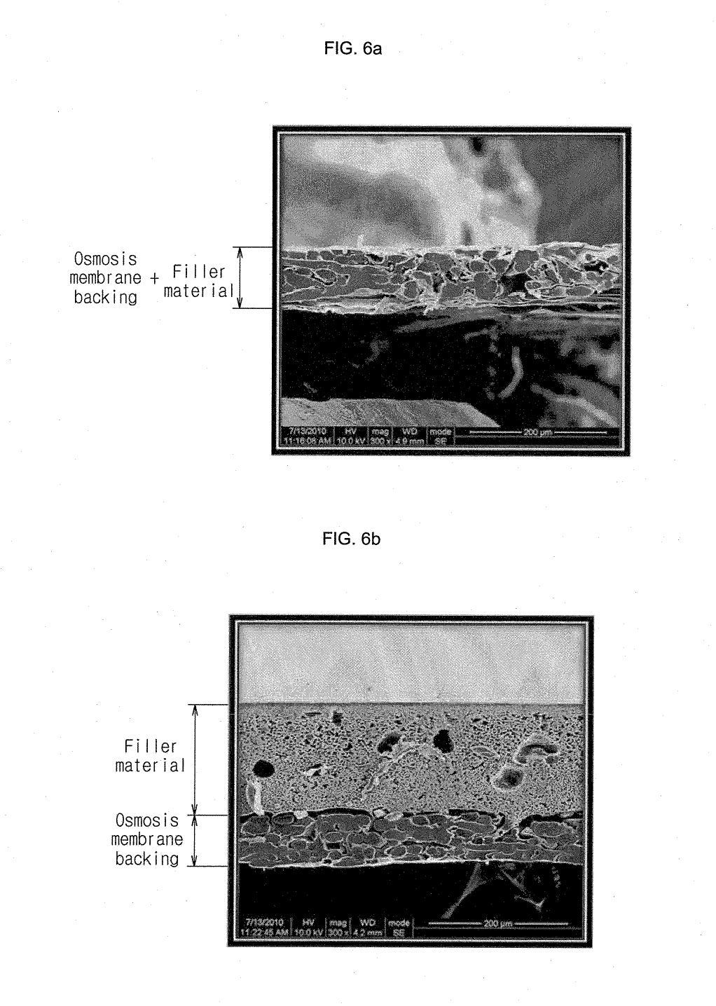

The mixing proportion of the non-cellulose polymer may be determined to be 10-30 vol % considering the penetration property of the non-cellulose polymer and the pore size. When the mixing proportion of the non-cellulose polymer is below 10 vol %, all the filler material may penetrate the osmosis membrane backing as shown in FIG. 6a. And, when the mixing proportion of the non-cellulose polymer is above 30 vol %, the filler material may not penetrate the osmosis membrane backing because of increased concentration, as shown in FIG. 6b.

After the osmosis membrane backing and the filler material are prepared, the filler material is coated on the osmosis membrane backing (S302). If a predetermined time passes in this state, some of the filler material diffuses into the osmosis membrane backing. As a result, the filler material is provided in the osmosis membrane backing and on the osmosis membrane backing. Some of the filler material may penetrate the osmosis membrane backing and form a sub-active layer.

Then, the osmosis membrane backing coated with the filler material is completely immersed in water (S303). As a result, the organic solvent and the pore-forming agent constituting the filler material are evaporated, and pores are formed in the non-cellulose polymer as the non-cellulose polymer is solidified (S304). Through this process, the fabrication of the forward osmosis membrane according to the present disclosure is completed (S305).

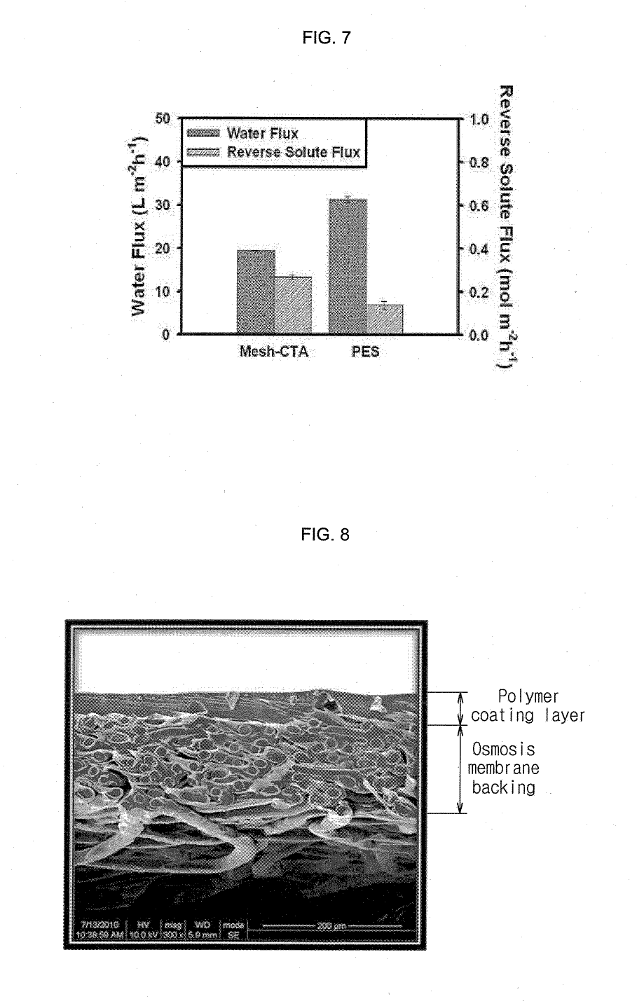

Now, water flux and reverse solute flux properties of the forward osmosis membrane according to an embodiment of the present disclosure will be described. FIG. 7 compares water flux and reverse solute flux properties of a forward osmosis membrane made from Hydration Technology, Inc. (HTI)'s cellulose triacetate (CTA) and a forward osmosis membrane made from polyethersulfone (PES) according to an embodiment of the present disclosure.

As seen from FIG. 7, the forward osmosis membrane made from PES according to the present disclosure exhibits a water flux of about 1.6 times that of the forward osmosis membrane made from HTI's CTA. It also exhibits a significantly reduced reverse solute flux as compared to the forward osmosis membrane made from HTI's CTA.

The forward osmosis membrane according to the present disclosure and the method for fabricating the same provide the following advantages.

Since the non-cellulose polymer which is hydrophilic and resistant to microorganisms is used as the material constituting the forward osmosis membrane, the forward osmosis membrane is effectively applicable in membrane bioreactors (MBRs) for treatment of sewage and wastewater which has relatively higher concentration of microorganisms. Further, the efficiency of forward osmosis can be improved by minimizing reverse solute flux.

While the present disclosure has been described with respect to the specific embodiments, it will be apparent to those skilled in the art that various changes and modifications may be made without departing from the spirit and scope of the disclosure as defined in the following claims.

What is claimed is:

1. A forward osmosis membrane comprising:
an osmosis membrane backing made of a porous material;
an active layer provided on the osmosis membrane backing; and
a support layer provided in the osmosis membrane backing,
wherein the active layer and the support layer are made of a non-cellulose polymer.

2. The forward osmosis membrane according to claim 1, wherein the non-cellulose polymer is polyethersulfone (PES).

3. The forward osmosis membrane according to claim 1, wherein the non-cellulose polymer is polyacrylonitrile (PAN).

4. The forward osmosis membrane according to claim 1, wherein the active layer is 0.5-50 μm thick, and the active layer plus the osmosis membrane backing is 50-250 μm thick.

5. The forward osmosis membrane according to claim 1, wherein the active layer has pores with a diameter of 0.01-10 nm on the surface.

6. The forward osmosis membrane according to claim 1, wherein the osmosis membrane backing comprises a nonwoven or nylon fabric having pores with a diameter of 0.1-100 μm.

7. The forward osmosis membrane according to claim 1, wherein an sub-active layer is further provided below the osmosis membrane backing and the sub-active layer is made of a non-cellulose polymer.

8. The forward osmosis membrane according to claim 7, wherein the active layer plus the sub-active layer is 0.5-50 μm thick, the forward osmosis membrane is 50-250 μm thick overall, and the active layer and the sub-active layer have pores with a diameter of 0.01-10 nm.

9. A method for fabricating a forward osmosis membrane comprising:
preparing a filler material comprising a non-cellulose polymer, an organic solvent for dissolving the non-cellulose polymer, and a pore-forming agent for inducing pore formation in the non-cellulose polymer;
coating the filler material on an osmosis membrane backing; and
immersing the osmosis membrane backing coated with the filler material in water, so that the organic solvent and the pore-forming agent are evaporated, and pores are formed in the non-cellulose polymer as the non-cellulose polymer is solidified.

10. The method for fabricating a forward osmosis membrane according to claim 9, wherein the filler material comprises a mixture of 10-30 vol % of the non-cellulose polymer, 50-85 vol % of the organic solvent, and 5-20 vol % of the pore-forming agent.

11. The method for fabricating a forward osmosis membrane according to claim 10, wherein the non-cellulose polymer is one of polyethersulfone (PES) and polyacrylonitrile (PAN).

12. The method for fabricating a forward osmosis membrane according to claim 10, wherein the organic solvent is dimethylacetamide (DMAc), dimethylformamide (DMF), N-methylpyrrolidone (NMP) or a combination thereof.

13. The method for fabricating a forward osmosis membrane according to claim 10, wherein the pore-forming agent is 1,3-dioxalane, polyvinylpyrrolidone (PVP), polyethylene glycol (PEG), acetone or a combination thereof.

14. The method for fabricating a forward osmosis membrane according to claim 9, wherein, in said immersing the osmosis membrane backing coated with the filler material in water, so that the organic solvent and the pore-forming agent are evaporated, and pores are formed in the non-cellulose polymer as the non-cellulose polymer is solidified, an active layer is formed on the osmosis membrane backing and a support layer is formed in the osmosis membrane backing as the organic solvent and the pore-forming agent are evaporated.

15. The method for fabricating a forward osmosis membrane according to claim 9, wherein the osmosis membrane backing comprises a nonwoven or nylon fabric having pores with a diameter of 0.1-100 μm.

16. The method for fabricating a forward osmosis membrane according to claim 9, wherein, in said immersing the osmosis membrane backing coated with the filler material in water, so that the organic solvent and the pore-forming agent are evaporated, and pores are formed in the non-cellulose polymer as the non-cellulose polymer is solidified, an active layer is formed on the osmosis membrane backing, a support layer is formed in the osmosis membrane backing and an sub-active layer is formed below the osmosis membrane backing as the organic solvent and the pore-forming agent are evaporated.
